(19) United States
(12) Patent Application Publication
(10) Pub. No.: US 2005/0185772 A1
(43) Pub. Date: Aug. 25, 2005

(54) [DIGITAL AUDIO RECORDING APPARATUS PROVIDING CALL LOGGING FUNCTION]

(76) Inventors: Chia-Li Chen, Taipei County (TW); Johnson Lee, Taipei County (TW); Hsiang-An Hsieh, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,122

(22) Filed: Jun. 21, 2004

(30) Foreign Application Priority Data
Feb. 25, 2004 (TW) 93202692

(51) Int. Cl. H04M 1/64

(52) U.S. Cl. 379/88.19; 379/67.1

(57) ABSTRACT

A digital audio recording apparatus having call logging function is provided. The digital audio recording apparatus is connected to a telephone set as well as an external line for automatic detecting/capturing call log information and recording audio signals therewith. Furthermore, digitized audio signals are saved in a portable storage media, e.g. a memory card, via the digital audio recording apparatus. Larger capacity and higher flexibility of data storage are thus provided, and the filing of call logs is properly managed as dialogue time is clocked.

### CROSS REFERENCE TO RELATED APPLICATIONS

This application claims the priority benefit of Taiwan application serial no. 93202692, filed on Feb. 25, 2004.

### BACKGROUND OF INVENTION

1. Field of Invention

The present invention relates to a digital audio recording apparatus, and more particularly, to a digital recording apparatus having automatic call logging function.

2. Description of the Related Art

In present time, the call logging apparatuses available in the market generally work with magnetic recording tape to take down dialogue content in analog form. Although it is easier to access and more user-friendly to use a magnetic tape recording, storage space is substantially limited. Therefore, it is required to frequently change the magnetic tape or erase data thereon, which is annoying to users.

On the other hand, a traditional analog magnetic tape only manages to take down audio information from dialogue, whereas incoming/outgoing telephone numbers or conversation time/date are not recorded. It is disadvantageous for further reference. Besides, one may take the risk that data recorded on a magnetic tape may vanish or deteriorate with time.

Present digital answering machine is categorized into two major families. The first recorder family is embodied as a digital recorder with a telephone line attached. The drawback of this first recorder family is that they are not capable of automatically detecting incoming calls and activating recording function accordingly, whereas manual operation is available. The second recorder family is embodied as a digital recorder as well, yet memory storage capacity is similar to a traditional analog recorder. On the other hand, this second recorder family with a built-in storage does not comply with transmission interface to computing system. Consequently, the second recorder family fails to operate file management and backup when the built-in storage is fully loaded.

### SUMMARY OF INVENTION

In light of the foregoing technology, the present invention provides a digital audio recorder having call logging function, having a recording apparatus and a call detecting module. The call detecting module is coupled to an external line and a telephone set, which is equipped with a detecting/capturing circuit for detecting incoming call vibration or dial-tone, and for capturing incoming/outgoing telephone numbers from the external line or the telephone set. A detecting activating signal and the captured data are transmitted to the recording apparatus according to the detection results. The recording apparatus includes a portable storage media, a timing circuit, and a microcontroller that is electrically coupled to the portable storage media and the timing circuit. As the timing circuit receives a detecting activating signal from the call detecting module, it is triggered by the signal in order to activate a timing function and to generate a call log including dialog time/date. The call log is processed by the microcontroller and stored based on a specific archival format thereto the portable storage media. On the other hand, the portable storage media stores information including the foregoing dialog filing data and the digital audio signals from users. Consequently, the present invention manages to detect incoming/outgoing calls and activate audio recording function, so that each incoming/outgoing telephone number and dialogue time/date are recorded for further reference and filing. Moreover, since the information is stored in a portable storage media, memory capacity and flexibility are no more limited by the built-in storage.

Additionally, the digital recording apparatus further includes a computer transmission interface, which couples to an external computing system or other storage media having larger capacity. Thus, the call log and the recorded audio signals are transferred to the systems from the portable storage media for further management, filing, and backup.

The present invention further discloses an audio input circuit and an audio playing interface for directly recording analog audio signals and playing digital audio signals respectively.

### BRIEF DESCRIPTION OF DRAWINGS

FIG. 1 is a schematic block diagram of the digital audio recording apparatus providing call logging function according to an embodiment of the present invention.

### DETAILED DESCRIPTION

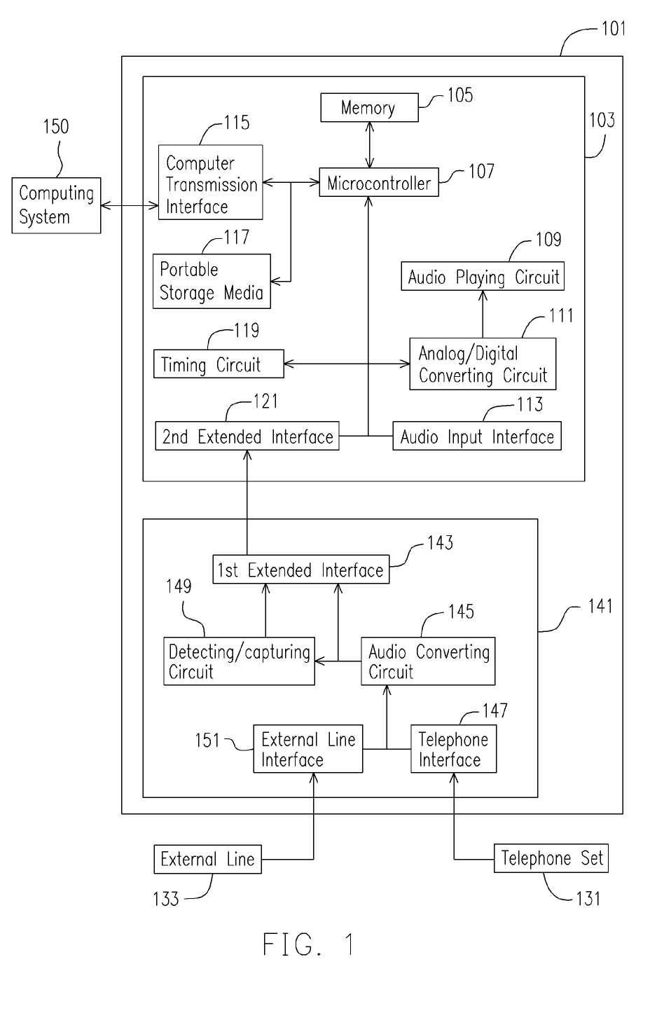

Referring to FIG. 1, it illustrates a block diagram of a digital audio recording apparatus providing call logging function according to the embodiment of the present invention. The digital audio recording apparatus 101 includes a recording apparatus 103 and a call detecting module 141. The call detecting module 141, coupled to an external line 133 and a telephone set 131, includes a detecting/capturing circuit 149 for detecting incoming call vibration or dial tone, functioning similarly to CallerID and DTMF Decoder. Therefore, an incoming/outgoing call log is captured, including incoming/outgoing telephone numbers and calling direction, from external line 133 or telephone set 131. A detecting activating signal and captured information are transmitted to the recording apparatus 103.

The recording apparatus 103,coupled to the call detecting module 141, includes a portable storage media 117, a timing circuit 119, and a microcontroller 107 electrically coupled to the portable storage media 117 and the timing circuit 119. The timing circuit 119 is triggered by the detecting activating signal and a timing function of the timing circuit 119 is activated thereby. Information including dialog start/end time and, dialogue length/date is generated and stored to a portable storage media 117, e.g. a silicon storage media, an optical storage media, and a magnetic storage media, etc., based on an archival format. The silicon storage media includes memory cards like MS (Memory Stick card), SD (Secure Digital card), SM (Smart Media card), and CF (Compact Flash card). The optical storage media includes a burnable disc, e.g. CD-R and CD-RW, etc. The magnetic storage media includes a 1.44″ floppy disk or a portable hard disc. Since the aforementioned portable storage media 117 is replaceable as needed, memory capacity of the storage media is extended.

The foregoing call detecting module 141 and the recording apparatus 103 include a corresponding first extended interface 143 and a corresponding second extended interface 121, respectively. The two interface components transmit signals with each other via a cable or wireless method, for example. The transmitted signal includes the user's audio signal that is transmitted between the telephone set 131 and the external line 133, the detecting activating signal and incoming/outgoing call logs generated by the detecting/capturing circuit 149, and the instructions given from the microcontroller 107 under work mode. The user's audio signals, also stored in the foregoing portable storage media 117, are linked to corresponding call log file.

The call detecting module 141 further includes a telephone interface 147, an external line interface 151,and an audio converting circuit 145 that is electrically coupled to the detecting/capturing circuit 149 and the first extended interface 143. The telephone line interface 147 is coupled to the telephone set 131 and is electrically coupled to the audio converting circuit 145, while the external line interface 151 is coupled to the external line and is electrically coupled to the telephone interface 147 and the audio converting circuit 145. The two interface components 147 and 151 both transmit user's audio signal in analog form for user's communication. Analog signals, including dial tone and incoming call vibration, are also transmitted via the two interface components for outputting a detecting activating signal from the detecting/capturing circuit 149 via the first extended interface 143. The detecting activating signal then triggers the timing circuit 119 and the microcontroller 107 of the recording apparatus 103 to record the audio signals. Moreover, the detecting/capturing circuit 148 and the recording apparatus 103 may suffer from being burned for analog signals may overwhelm the voltage level carried by the external line 133 or the telephone set 131. Therefore, an analog signal with a high voltage level is usually modulated in advance by the audio converting circuit 145 to a range within the general voltage capability of integrated circuit, e.g. −5˜+5V. The modulated signals are then transmitted to the recording apparatus 103 via the first extended interface 143 for further digitization (will be described afterwards), and the digitized information and the call log are filed and saved by the microcontroller 107 thereafter.

A data format suitable for filing according to one embodiment in the present invention is described herein. The data format includes the aforementioned conversation data, start/end time, conversation length, incoming/outgoing call direction and/or telephone number, and even a filing address indicating where to record user's audio signals. Therefore, a user manages to request the audio signals via linkage thereto. The filing system is named, for example, according to recording date and call numbers for further searching and referencing. For example, “031120001.wav” refers to the first call recorded on Nov. 20 , 2003. The following information, such as 031120, 14:00-14:10, 10 min, IN, (02)891118341, corresponds to an incoming call (IN) at two o'clock in the afternoon on November 20^{th}, 2003, the telephone number is (02)89118341, and the dialogue ended at two-ten in the afternoon, which lasted for 10 minutes. When a user refers to the call log of this incoming call, all information about this call is revealed and audio signals are played upon request.

The recording apparatus 103 in this present invention further includes a computer transmission interface 115, which is electrically coupled to the microcontroller 107, the portable storage media 117, and to another external computing system 150, or other storage media having larger memory capacity via cable or wireless communication, for example. The call log files and audio signals are thus transferred from the portable storage media 117 to the aforementioned external systems for further management and backup.

Moreover, the recording apparatus 103 further includes audio input/output components, such as an audio playing circuit 109 (e.g. a speaker), an audio input interface (e.g. a microphone) 113,and an analog/digital converting circuit 111 that is electrically coupled to the microcontroller 107, the audio playing circuit 109, and the audio input interface 113. The audio playing circuit 109 serves to play user's audio signals stored in the portable storage media 117, as well to convert digitized audio signal to a analog signals through the analog/digital converting circuit 111 before playing. The audio input interface 113 is electrically coupled to the microcontroller 107 and the second extended interface 121 for directly recording external analog audio signals. The recorded analog audio signals are converted to digital audio signals by the analog/digital converting circuit ill and are saved in the portable storage media 117 by the microcontroller 107. Additionally, the input interface 113 provides a channel to communicate with another party on the external line 133 via the second extended interface 121 and the call detecting module 141, so that the local user manages to correspond with the hands-free speaker component of the telephone set 131.

Furthermore, besides analog-to-digital signal conversion for the audio playing circuit 109 and the audio input interface 113, the analog/digital converting circuit 111 also serves to digitize modulated analog signals from the foregoing call detecting module 141. Thus, the microcontroller 107 saves or transfers the digitized data to the portable media 117 or to the external computing system 150 for backup, respectively.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

1. A digital audio recording apparatus, comprising a recording apparatus and a call detecting module coupling to an external line and a telephone set, the call detecting module comprising:
a detecting/capturing circuit, detecting and capturing incoming/outgoing call information from said external line and said telephone set, and transmitting a activating signal and said captured incoming/outgoing call information to said recording apparatus according to detected result;
said recording apparatus comprising:
a portable storage media;
a timing circuit, wherein a timing function is triggered by the detecting activating signal, and a call log is generated; and
a microcontroller, electrically coupling to said portable storage media and said timing circuit, receiving call log and incoming/outgoing call information, and saving said call log information and said incoming/outgoing call information to the portable storage media in an archival format.

2. The digital audio recording apparatus as recited in claim 1, wherein said incoming/outgoing call information comprises a telephone number and an incoming/outgoing direction.

3. The digital audio recording apparatus as recited in claim 1, wherein said call log comprises a dialogue start/end time, a call length and a date.

4. The digital audio recording apparatus as recited in claim 1, wherein said portable storage media is one selected from the group consisting of a silicon storage media, an optical storage media, and a magnetic storage media.

5. The digital audio recording apparatus as recited in claim 1, wherein said call detecting module and said recording apparatus further comprise a first extended interface and a second extended interface respectively to transmit a user's audio signal transmitted by the telephone set or the external line, said detecting activating signal, said incoming/outgoing call information and an operative instruction given by said microcontroller.

6. The digital audio recording apparatus as recited in claim 5, wherein one of a cable transmission method and a wireless transmission method is performed between said first extended interface and said second extended interface.

7. The digital audio recording apparatus as recited in claim 5, wherein said call detecting module further comprises:
a telephone interface, coupling to said telephone set, to transmit said user's audio signal in analog form and an outgoing call information;
an external line interface, coupling to said external line and electrically coupling to said telephone interface, to transmit said user's audio signal in analog form and an incoming call information; and
an audio converting circuit, electrically coupling to said telephone interface, said external line interface, said detecting/capturing circuit and said first extended interface, receiving said incoming/outgoing call information in analog form and said user's audio signal, and transmitting said incoming/outgoing call information to said digital audio recording apparatus via said first extended interface for digitization.

8. The digital audio recording apparatus as recited in claim 1, wherein said digital audio recording apparatus further comprises a computer transmission interface, which is electrically coupled to said microcontroller and said portable storage media, and communicates with an external computing system or an external storage media, to storage said information in said external computing system or said storage media.

9. The digital audio recording apparatus as recited in claim 5, wherein said recording apparatus further comprises:
an audio playing circuit, to play said user's audio signal stored in the portable storage media;
an audio input interface, electrically coupling to said microcontroller and said second extended interface, to directly receiving an analog audio signal inputting from the external line; and
an analog-to-digital converting circuit (ADC), electrically coupling to said microcontroller, said audio playing circuit and said audio input interface.
